(19) United States
(12) Patent Application Publication
(10) Pub. No.: US 2026/0067543 A1
(43) Pub. Date: Mar. 5, 2026

(54) SYSTEM FOR REAL-TIME WAVEFORM CONVERSION BASED ON ATTACK LOCATION AND ATTACK SITUATION INFORMATION IN LIVE FOOTBALL MATCHES, AND METHOD THEREOF

(71) Applicant: AIMBROAD INC., Seoul (KR)

(72) Inventor: Soo Jin JANG, Hanam-si (KR)

(73) Assignee: AIMBROAD INC., Seoul (KR)

(21) Appl. No.: 18/816,980

(22) Filed: Aug. 27, 2024

(51) Int. Cl. H04N 21/81; G06T 11/20; H04N 21/2187; H04N 21/234

(52) U.S. Cl. CPC H04N 21/8133; G06T 11/26; H04N 21/2187; H04N 21/23418

(57) ABSTRACT

According to the present disclosure provides a system and a method for converting a real-time information waveform based on real-time attack position and attack situation information of football matches and more specifically, converts a real-time information waveform based on a real-time attack position and attack situation information of football matches to provide infographic contents, that is, frequency type infographics, to allow fans who have difficulty in watching TV in real-time so that viewers may be easily synchronized with the broadcasted live football matches.

### BACKGROUND

### Field

The present disclosure relates to a system for converting a real-time information waveform based on a real-time attack position and attack situation information of football matches and a method thereof, and more particularly, to a system for converting a real-time information waveform based on a real-time attack position and attack situation information of football matches to provide infographic contents, that is, frequency type infographics, to allow fans who have difficulty in watching TV in real-time to recognize real-time match situations and a method thereof.

### Description of the Related Art

The most popular sport in the world is by far football. According to the Federation Internationale de Football Association (FIFA), there are 5 billion football fans worldwide, and there are reports that about 242 million people enjoy playing football games. In addition, there are more FIFA member countries than UN member countries.

Recently, as football has become more popular, the fan base for star players has expanded, and not only all the matches are being broadcasted live or recorded by broadcasters, but also many experts are also analyzing the matches and providing commentary.

For example, in Korean Unexamined Patent Application Publication No. 10-2004-0063408 (entitled Football game analysis system), data analysis is performed by simply quantifying actions such as shooting, passing, and fouls that occur during the game to manage records and analysis data generated during the game using a computer system. Therefore, there is a problem in that the actual game situation is not properly reflected.

Specifically, overseas football leagues, such as the Premier League, La Liga, Bundesliga, Serie A, Ligue 1, and UEFA Champions League, which are filled with popular star players, are being broadcasted and the broadcast of the World Cup, a football festival for people all over the world, is a must-see for football fans.

In the case of football analysis and commentary, the strategic analysis using match videos is the trend, and data-based analysis has been introduced in advanced football countries such as the UK, but there has been a problem that there is no proper means for general fans to view or analyze the flow of the game during live broadcasts.

This becomes an issue because watching, analyzing, and predicting of the broadcasts of professional football matches are becoming a daily part of life for not only professionals but also ordinary football fans. Therefore, in order to meet their needs, a program that allows them to watch football games more easily and intuitively needs to be developed.

Football has fans all over the world, centered on TV visual media, but with the recent spread of smartphones, digital consumption patterns are rapidly changing from personalization to mass consumption. The most prominent consumption pattern among them is definitely the highlight.

If infographic contents that allow people to recognize the game situation in real time, that is, infographics in the form of frequencies are provided, intuitive real-time consumption without complexity is possible.

### RELATED ART DOCUMENT

### Patent Document

Korean Patent Application No. 10-2007-0047890: Football broadcasting system which displays data by manual input
Korean Unexamined Patent Application Publication No. 10-2004-0063408: Football game analysis system

### SUMMARY

In order to solve the above-mentioned problems, an object of the present disclosure is to provide a system for converting a real-time information waveform based on a real-time attack position and attack situation information of football matches to provide infographic contents, that is, frequency type infographics, to allow fans who have difficulty in watching TV in real-time to recognize real-time match situations and a method thereof.

Further, an object of the present disclosure is to provide a system for converting a real-time information waveform based on a real-time attack position and attack situation information of football matches and a method thereof to provide a frequency type infographics not only to enable intuitive consumption without complexity, but also to become an alternative method for avoiding and adjusting problems due to royalty.

However, objects of the present invention are not limited to the above described objects and other objects which have not been mentioned above will be more apparent to those skilled in the art from a reading of the following description.

In order to achieve the above-mentioned objects, according to an aspect of the present disclosure, a real-time information waveform converting system based on real-time attack position and attack situation information of a match includes: a real-time analysis server 400; a plurality of digital content servers 500 which provides football broadcast contents via on-line; and an information waveform providing server 300 which provides football broadcast contents provided from a plurality of digital content servers 500 to the smart terminal 100 together with football player information provided from a real-time analysis server 400 based on a football wave corresponding to a real-time information waveform based on a real-time attack position and attack situation information of a football match.

At this time, the real-time analysis server 400 automatically or manually analyzes real-time external data for at least one or more players of both teams in one football match in a football broadcast content provided by the digital content server 500 and then provides the analyzed data to the information waveform providing server 300.

Further, the football wave which represents real-time information waveform based on a real-time attack position and attack situation information of a football match is a digital graphic which convert real-time collected data of football matches into a digital signal, that is, an information waveform (frequency), including the meaning of attack positions, attack build-up, attack strengths, etc., just as the intensity of voice or sound is converted into an information waveform (frequency) which is a digital signal.

In order to achieve the above-mentioned object, according to another aspect of the present disclosure, a real-time information waveform converting method based on real-time attack position and attack situation information of a match includes: a first step of allowing a smart terminal 100 to provide a request for a selected football broadcast to an information waveform providing server 300 through a network 200; and a second step of allowing the information waveform providing server 300 to provide football broadcast contents provided from a plurality of digital content servers 500 to the smart terminal 100 together with football player information provided from a real-time analysis server 400 based on a football wave corresponding to a real-time information waveform based on a real-time attack position and attack situation information of a football match.

At this time, the real-time analysis server 400 automatically or manually analyzes real-time external data for at least one or more players of both teams in one football match in a football broadcast content provided by the digital content server 500 and then provides the analyzed data to the information waveform providing server 300.

According to the exemplary embodiment of the present disclosure, the real-time information waveform converting system and method based on a real-time attack position and attack situation information of football matches provide infographic contents, that is, frequency type infographics, to fans who have difficulty in watching TV in real-time to recognize real-time match situations.

According to another exemplary embodiment of the present disclosure, the real-time information waveform converting system and method based on a real-time attack position and attack situation information of football matches provide the frequency type infographic to enable intuitive consumption without complexity.

### BRIEF DESCRIPTION OF THE DRAWINGS

FIG. 1 is a view illustrating a real-time information waveform converting system 1 based on a real-time attack position and attack situation information of football matches according to an exemplary embodiment of the present disclosure;

FIG. 2 is a view illustrating components of an information waveform providing server 300 of a real-time information waveform converting system 1 based on a real-time attack position and attack situation information of football matches according to an exemplary embodiment of the present disclosure;

FIG. 3 is a view illustrating that an UI screen which displays a real-time information waveform based on a real-time attack position and attack situation information of football matches is provided on a smart terminal 100 in a real-time information waveform converting system 1 based on a real-time attack position and attack situation information of football matches;

FIGS. 4 and 5 are views illustrating a concept provided in a real-time information waveform converting system 1 based on a real-time attack position and attack situation information of football matches according to an exemplary embodiment of the present disclosure;

FIG. 6 is a view for explaining position (x, y) data analysis in a real-time information waveform converting system 1 based on a real-time attack position and attack situation information of football matches according to an exemplary embodiment of the present disclosure;

FIG. 7 is a view for explaining real-time external data analysis in a real-time information waveform converting system 1 based on a real-time attack position and attack situation information of football matches according to an exemplary embodiment of the present disclosure;

FIGS. 8 and 9 are views illustrating that a real-time passing development process is implemented on a UI screen in a real-time information waveform converting system 1 based on a real-time attack position and attack situation information of football matches according to an exemplary embodiment of the present disclosure;

FIG. 10 is a view illustrating a real-time information waveform converting method based on a real-time attack position and attack situation information of football matches according to an exemplary embodiment of the present disclosure.

### DETAILED DESCRIPTION OF THE EMBODIMENT

Hereinafter, an exemplary embodiment according to the present disclosure will be described in detail with reference to the accompanying drawings in detail. In the following description of the present disclosure, a detailed description of known configurations or functions incorporated herein will be omitted when it is determined that the detailed description may make the subject matter of the present disclosure unclear.

In the present disclosure, when any one component “transmits” data or a signal to the other component, it means that the one component may directly transmit the data or signal to the other component or transmit the data or signal to the other component by means of at least one other component.

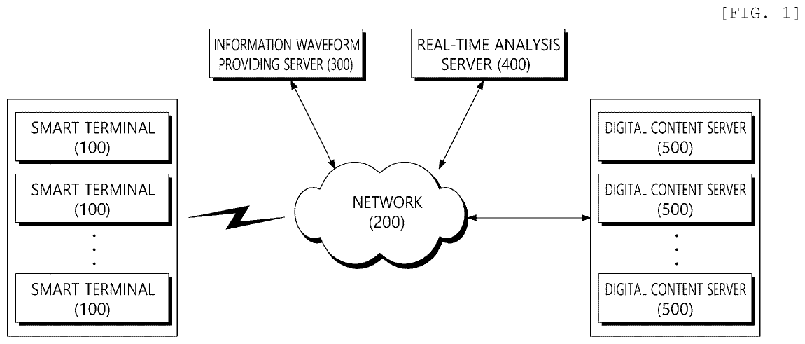

FIG. 1 is a view illustrating a real-time information waveform converting system 1 based on a real-time attack position and attack situation information of football matches according to an exemplary embodiment of the present disclosure. Referring to FIG. 1, a real-time information waveform converting system 1 based on a real-time attack position and attack situation information of football matches includes a plurality of smart terminals 100, a network 200, an information waveform providing server 300, a real-time analysis server 400, and a plurality of digital content servers 500. The information waveform providing server 300 provides football broadcast contents provided from the plurality of digital content servers 500 to the smart terminals 100 together with football player information provided from the real-time analysis server 400 based on a football wave corresponding to a real-time information waveform based on real-time attack position and attack situation information of the football matches.

Here, in the present disclosure, the football wave, that is, a real-time information waveform based on real-time attack position and attack situation information of the football matches refers to digital graphics which convert real-time collected data of football matches into a digital signal, that is, an information waveform (frequency), including the meaning of attack positions, attack build-up, attack strengths, etc., just as the intensity of voice or sound is converted into an information waveform (frequency) which is a digital signal. As represented in the following Table 1, waveforms of music and football may be compared.

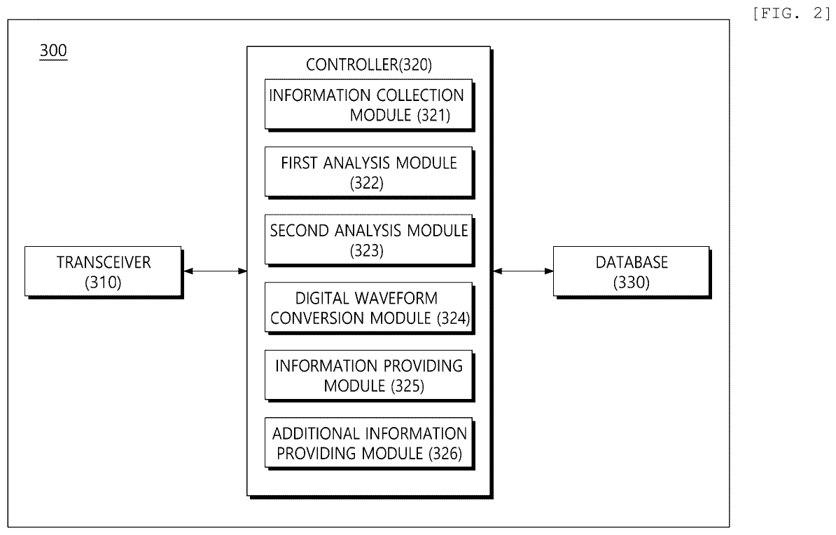

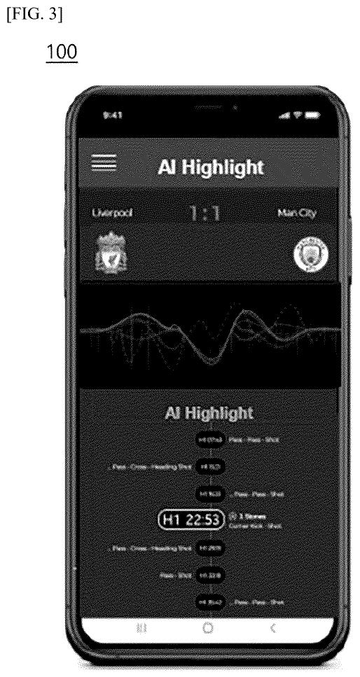

FIG. 2 is a view illustrating components of an information waveform providing server of a real-time information waveform converting system 1 based on a real-time attack position and attack situation information of football matches according to an exemplary embodiment of the present disclosure. FIG. 3 is a view illustrating that an user interface (UI) screen which displays a real-time information waveform based on a real-time attack position and attack situation information of football matches is provided on a smart terminal 100 in a real-time information waveform converting system 1 based on a real-time attack position and attack situation information of football matches.

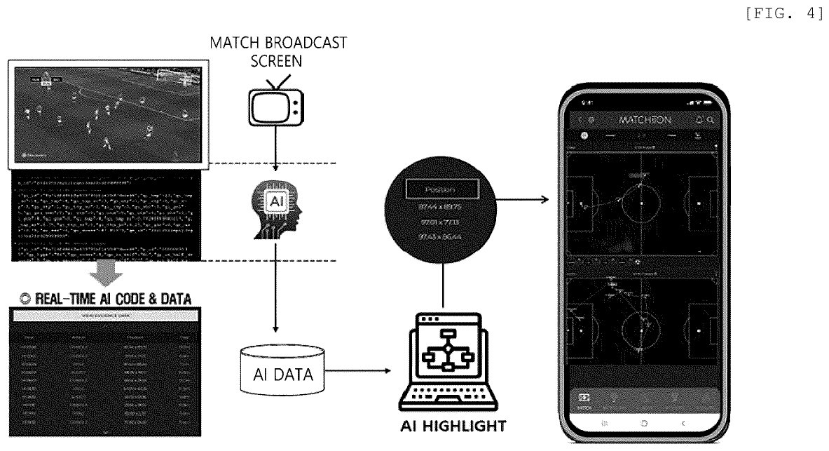

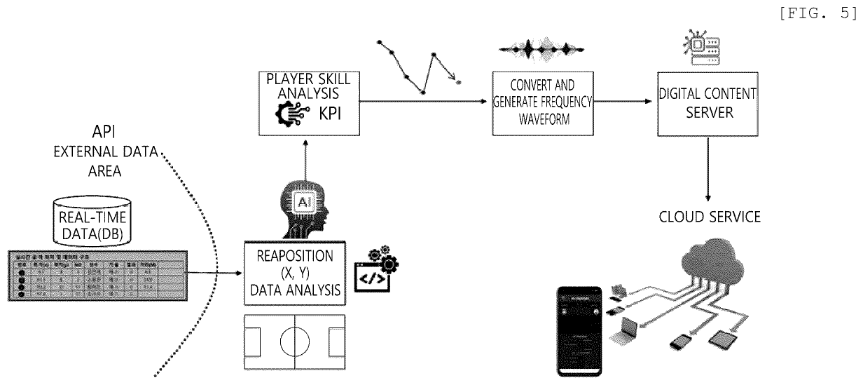

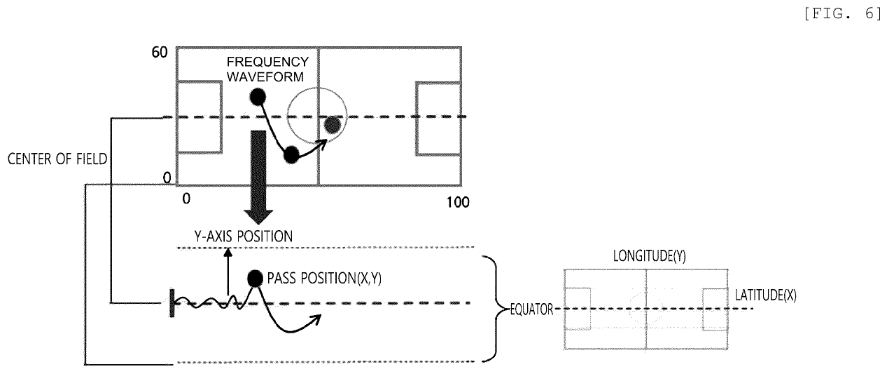

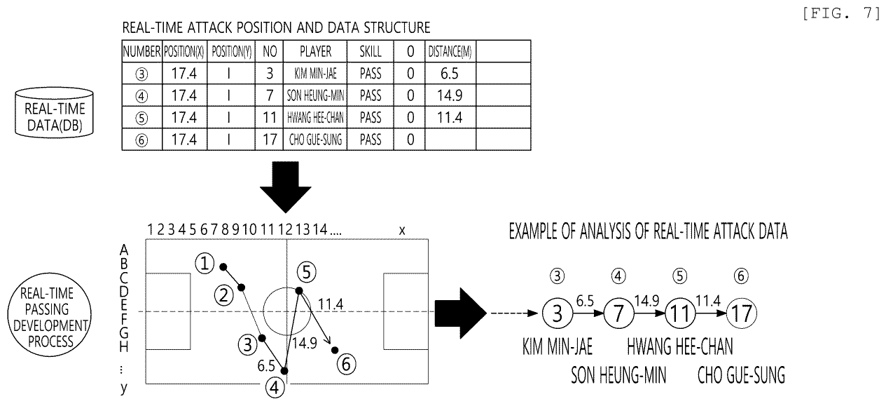

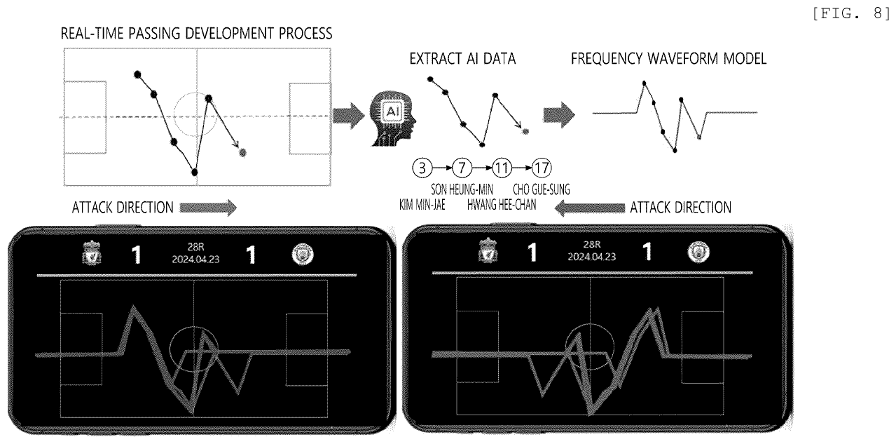

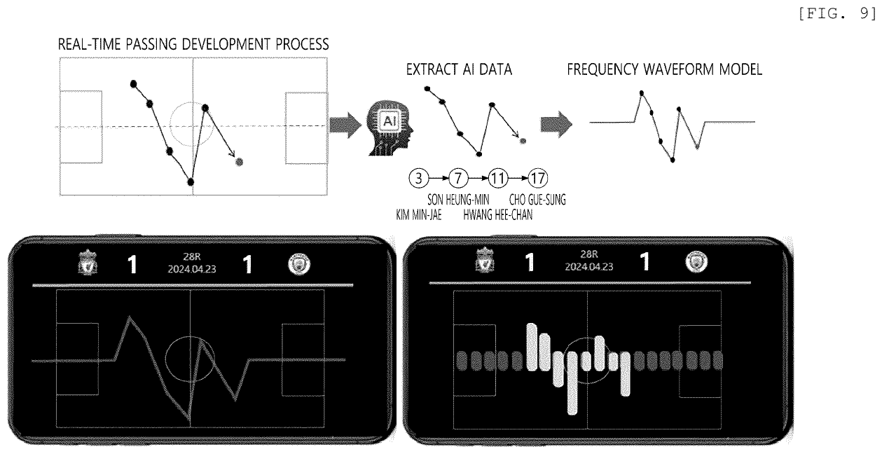

FIGS. 4 and 5 are views illustrating a concept provided in a real-time information waveform converting system 1 based on a real-time attack position and attack situation information of football matches according to an exemplary embodiment of the present disclosure. FIG. 6 is a view for explaining position (x, y) data analysis in a real-time information waveform converting system 1 based on a real-time attack position and attack situation information of football matches according to an exemplary embodiment of the present disclosure. FIG. 7 is a view for explaining real-time external data analysis in a real-time information waveform converting system 1 based on a real-time attack position and attack situation information of football matches according to an exemplary embodiment of the present disclosure. FIGS. 8 and 9 are views illustrating that a real-time passing development process is implemented on a UI screen in a real-time information waveform converting system 1 based on a real-time attack position and attack situation information of football matches according to an exemplary embodiment of the present disclosure.

First, referring to FIG. 2, the information waveform providing server 300 includes a transceiver 310, a controller 320, and a database 330. The controller 320 includes an information collection module 321, a first analysis module 322, a second analysis module 323, a waveform conversion module 324, an information providing module 325, and an additional information providing module 326.

The information collection module 321 performs authentication by different methods, such as a member ID and a password or a phone number for request for a football broadcast, after access from each smart terminal 100 through the network 200.

The information collection module 321 is receiving football broadcast information which is being currently provided from each digital content server 500, in a predetermined cycle or real-time, through the network 200. Therefore, after providing football broadcast information (broadcast start time, a broadcast time line, team information, and line-up) for every digital content server 500 to the smart terminal 100 through the network 200, the information collection module analyzes whether the football broadcast corresponding to the football broadcast information selected by the smart terminal 100 is live broadcast.

Next, in the case of the live broadcast, the information collection module 321 performs a first information collecting process of not only receiving the football broadcast content from the digital content server 500 which provides a football broadcast content according to the football broadcast information selected through the network 200 to provide the football broadcast content to the smart terminal 100, but also repeatedly storing and deleting a content data unit which is divided by a predetermined image frame section on and from the database 330 to be analyzed by the first and second analysis modules 322 and 323.

Further, the information collection module 321 performs a second information collecting process of controlling the transceiver 310 to receive real-time external data in response to a real-time AI analysis request for the football broadcast content from the real-time analysis server 400 and to receive the real-time external data matching a time order when each image frame which configures the content data unit is stored on the database 330.

Here, the real-time external data may include a player squad number, a player's name, used skills (passes), results, or distances (M) as illustrated in FIG. 7.

The first analysis module 322 generates position (x, y) data to generate a graph of a frequency waveform curve by utilizing real-time player skill points, as a more specific example, player passing points (X, Y), on a virtual area with the same frequency as a football field as vertexes, to allow the waveform conversion module 324 to generate a real-time information waveform based on real-time attack position and attack situation information of football matches.

As an exemplary embodiment for this, when skill event information is generated by analyzing a distance between a first object which is recognized as a ball and a second object which is recognized as a player in the inside recognized as the field in each image frame in a content data unit during the first information collecting process to be within a predetermined distance, the first analysis module 322 analyzes position (x, y) data of the first object and the second object in real-time to provide the data to the waveform conversion module 324.

As a more specific exemplary embodiment, when the position (x, y) data is analyzed, the first analysis module 322 analyzes an attack direction of the second object (that is, football player) along the length of the x-axis (latitude, for example, 0 to 100) of the field and along the length of the y-axis (longitude, for example, 0 to 60), as illustrated in FIG. 5, and sets a center of the field in the analyzed attack direction as a center for the information waveform to provide real-time attack direction information and position information of the center of the field on the content data to the waveform conversion module 324.

The second analysis module 323 analyzes player data. In order to utilize a player squad number (and/or player's name), used skills (passes or shootings), results, and distances (M) corresponding to each data parameter from the real-time external data provided from the digital content server 500, the second analysis module 323 provides the real-time external data for the second object recognized by the first analysis module 322 to the waveform conversion module 324 to extract and utilize desired data from data about the player through the analysis information of the recognized real-time external data for the second object.

When a player corresponding to one player's squad number, among real-time external data, makes a pass, among the skills, according to the real-time analysis by the second analysis module 323 and skill event information about a player other than the player who uses the occurred skill by the first analysis module 322 is generated and transmitted again, the waveform conversion module 324 converts position (x, y) data where the skill event information of one player who makes a pass, generated in the first analysis module 322 is generated and position (x, y) data where the skill event information of a player who receives the pass is generated into one waveform.

Thereafter, the waveform conversion module 324 sets position information of a center of the field provided by the first analysis module 322 as a center position for generating a waveform graph. The waveform conversion module 324 sets a waveform graph parameter according to real-time attack direction information, that is, colors of FIG. 8 and graph types, such as “frequency mode”, “pulse mode”, and “graphic bar mode” as illustrated in FIG. 9 and the following Table 2, to generate a real-time waveform graph. The frequency mode corresponds to a connected position of the team passes and an attack build-up direction. The pulse mode reproduces a specific upward movement of the continuous passing points of the team attack at a specific time (within 3 to 10 seconds) in real time with pulses. The graphic bar mode recognizes the attack point as up and down vertexes in the same manner as the pulse mode to display the left and right attack directions with a graphic bar.

In the meantime, when a player corresponding to one player's squad number, among real-time external data, makes a pass, among the skills, according to the real-time analysis by the second analysis module 323 and skill event information about a player, other than the player who uses the generated skill is not generated by the first analysis module 322 or skill event information corresponding to an opponent player who is the player other than the player using the generated skill is generated, the waveform conversion module 324 generates the real-time waveform graph to recognize that the turn-over occurs by fixing a y-axis (longitude) like the section A of FIG. 8 and advancing a predetermined distance to an opponent side on the x-axis where skill event information is generated.

The information providing module 325 controls the transceiver 310 to provide the real-time waveform graph generated in the waveform conversion module 324 to the smart terminal 100 through the network 200.

Further, the information providing module 325 controls the transceiver 310 to provide not only the real-time waveform graph, but also a player squad number (and/or player name), used skills (passes or shootings), results, and distances M corresponding to each data parameter from the real-time external data about a player who generates skill event information related to generation of the real-time waveform graph, provided from the second analysis module 323, to the smart terminal 100 in real-time through the network 200. Further, the information providing module 325 controls the transceiver 310 to generate match statistics for every player obtained by combining skills (passes and shootings), results, distances M by utilizing real-time external data for one football match and then provide the statistics to the smart terminal 100 through the network 200.

The additional information providing module 326 generates a data record obtained by converting an attack skill of one player for the skills into a football big data code and stores the data record in the database 330 with the format of “player name (squad number)+time+skill factor+position (x, y coordinate)+skill result value (success or fail)+result position (x, y coordinate). Here, the skill factor further a corner kick K, header H, and free kick F in addition to the pass P, the cross C, and the shooting S. The skill result value (success or fail) may be set to O (success), B (blocking), or X (fail), but is not limited thereto.

The additional information providing module 326 controls the transceiver 310 so as to provide data records for every player and every team through the network 200 in response to the request of the user of the smart terminal 100.

According to still another exemplary embodiment of the present disclosure, the information waveform providing server 300 generates a real-time information waveform based on real-time attack position and attack situation information of football matches with respect to a movement of a ball and further generates a real-time information waveform based on a real-time attack or defense position and attack or defense situation information for every player. At this time, when the real-time information waveform is generated, a vertex indicating a passing point for movement of a position of a ball is represented to be different for every team so that the flow of the ball may be more accurately represented. Further, in the case of the defense, the flow, such as aback pass, may be further represented and unlike the attack, may be represented with different colors or thickness of waveforms.

In the meantime, the real-time analysis server 400 automatically or manually analyzes real-time external data for at least one or more players of both teams in one football match in a football broadcast content provided by the digital content server 500 and then provides the analyzed data to the second analysis module 323 of the information waveform providing server 300.

Here, the football broadcast content is stored in a DB of the digital content providing server 500 and is provided as one image information with a field of view for the entire football field or image information for every football player to extract transmission information based on the ball between the players.

Accordingly, each real-time analysis server 400 receives information through access to the DB and authentication of the digital content providing server 500 through the network 200 for the football broadcast content. Further, when the received football broadcast content is automatically analyzed, previously stored football player image information of a football player and image information of a person who controls the ball extracted from the football broadcast contents are compared to extract a player's name (squad number) as a first step. Further, the continuous motion of the image information of the person corresponding to the extracted player name (squad number) is compared with standardized skill data formed by at least two frame information in the football player DB. Therefore, if an image matching probability is equal to or higher than a predetermined probability, the player name (squad number) can be extracted as a second step.

That is, each real-time analysis server 400 determines a football player and a skill for digital image data extracted from the football broadcast content. To this end, as previous football player image information, various football player image patterns such as image information of a football player, a tilted image pattern of the football player, a reversed pattern, and slightly tilted image pattern are compared with patterns of the football player included in the digital image data to determine the football player and skills in the digital image.

Here, the skill may be skill data and a minimum skill unit element for analyzing valid attack skills to score a goal in the ‘opponent attack side’, such as ‘Pass’, ‘Shooting’, or ‘Cross’, which correspond to one of predetermined attack categories.

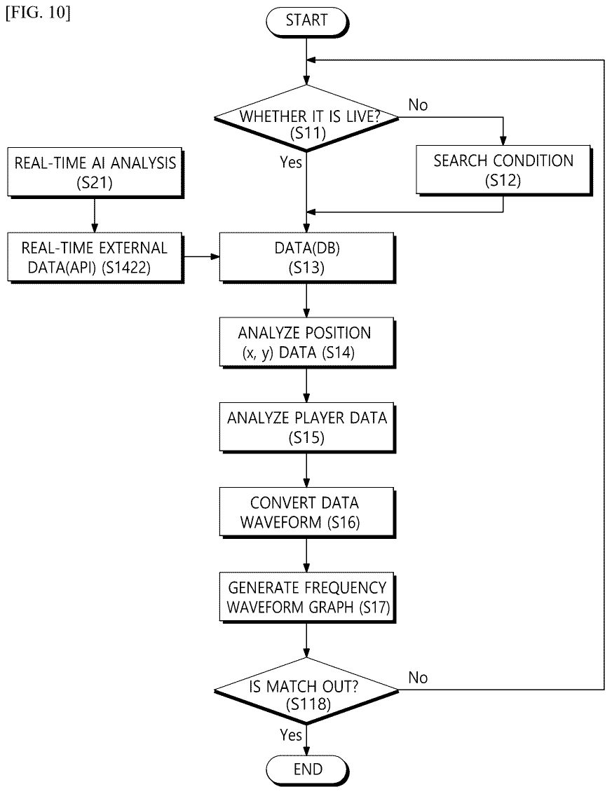

FIG. 10 is a view illustrating a real-time information waveform converting method based on a real-time attack position and attack situation information of football matches according to an exemplary embodiment of the present disclosure. Referring to FIG. 10, the information waveform providing server 300 determines whether a football broadcast provided by the requested digital content server 500 according to a real-time information waveform service request based on real-time attack position and attack situation information of a match of the smart terminal 100 through the network 100 is live broadcast corresponding to the real-time broadcast (S11). As a result of the determination in step S11, if it is not the live broadcast, the information waveform providing server 300 proceeds to step S12 to extract a football broadcast which satisfies a live broadcast search condition to provide the football broadcast corresponding to the live broadcast to the smart terminal 100 through the network 200. In the case of a recorded football broadcast rather than a live broadcast, another embodiment may be provided in which the smart terminal (100) requests the database (330) to provide previously generated football broadcast information waveform information so as to match the football broadcast to the smart terminal (100) through the network (200) in a time stream.

In the meantime, as the result of the determination of step S11, if it is a live broadcast, the information waveform providing server 300 performs a first information collecting process of not only receiving the football broadcast content from the digital content server 500 which provides football broadcast contents according to the football broadcast information selected by the smart terminal 100 through the network 200 to provide the football broadcast content to the smart terminal 100 and repeatedly storing and deleting a content data unit which is divided by a predetermined image frame section on and from the database 330 to analyze the received football broadcast content (S13).

Further, not only in the step S13, the information collection module 300 performs a second information collecting process of receiving real-time external data in response to a real-time AI analysis request for the football broadcast from the real-time analysis server 400 and receiving the real-time external data matching a time order when each image frame which configures the content data unit is stored on the database 330.

The information waveform providing server 300 performs the second information collecting process to repeatedly store and delete the divided content data unit on and from the database 330, like the first information collecting process.

In the meantime, during the data collecting process of the step S13, as the real-time external data, data provided according to the real-time AI analysis process S21 by the real-time analysis server 400 and a real-time external data (API) providing process S22 is received by the information waveform providing server 300.

To be more specific, the real-time analysis server 400 automatically or manually analyzes real-time external data about at least one or more players of both teams in one football match in a football broadcast content provided by the digital content server 500 and then provides the analyzed data to the process of the step S13 of the information waveform providing server 300.

Here, the football broadcast content is stored in a DB of the digital content providing server 500 and is provided as one image information with a field of view for the entire football field or image information for every football player to extract transmission information based on a ball between the players.

Accordingly, each real-time analysis server 400 receives information through access to the DB and authentication of the digital content providing server 500 through the network 200 for the football broadcast content. Further, when the received football broadcast content is automatically analyzed, previously stored football player image information of a football player and image information of a person who controls the ball extracted from the football broadcast contents are compared to extract a player's name (squad number) as a first step. Further, if the continuous motion of the image information of the person corresponding to the extracted player name (squad number) is compared with standardized skill data formed by at least two frame information in the football player DB. Therefore, if an image matching probability is equal to or higher than a predetermined probability, the player name (squad number) can be extracted as a second step.

That is, each real-time analysis server 400 determines a football player and a skill for digital image data extracted from the football broadcast content. To this end, as previous football player image information, various football player image patterns such as image information of a football player, a tilted image pattern of the football player, a reversed pattern, and slightly tilted image pattern are compared with patterns of the football player included in the digital image data to determine the football player and skills in the digital image.

Here, the skill may be skill data and a minimum skill unit element for analyzing valid attack skills to score a goal in the ‘opposing attack zone’, such as ‘Pass’, ‘Shooting’, or ‘Cross’, which correspond to one of predetermined attack categories.

After the step S13, the information waveform providing server 300 analyzes position (x, y) data.

To be more specific, when skill event information is generated by analyzing a distance between a first object which is recognized as a ball and a second object which is recognized as a player in the inside recognized as a field in each image frame of a content data unit during the first information collecting process to be within a predetermined distance in the first information collecting process of the step S13, the information waveform providing server 300 analyzes position (x, y) data of the first object and the second object in real-time.

In the meantime, when the position (x, y) data is analyzed, the information waveform providing server 300 analyzes an attack direction of the second object (that is, football player) along the length of the x-axis (latitude, for example, 0 to 100) of the field and along the length of the y-axis (longitude, for example, 0 to 60), as illustrated in FIG. 5 and sets a center of the field in the analyzed attack direction as a center for information waveform to identify real-time attack direction information and position information of the center of the field on the content data.

After the step S14, the information waveform providing server 300 analyzes player data (S15).

To be more specific, the information waveform providing server 300 extracts desired data, among data about the football player through analysis information of real-time external data for the second object recognized in step S14 to utilize a player squad number (and/or player name), used skills (passes or shootings), results, and distance (M) corresponding to each data parameter from the real-time external data provided from the digital content server 500.

After the step S15, the information waveform providing server 300 converts the data waveform.

To be more specific, when a player corresponding to one player's squad number, among real-time external data, makes a pass, among the skills, according to the real-time analysis in step S15 and skill event information about a player other than the player who uses the occurred skill by the step S14 is generated and transmitted, the information waveform providing server 300 converts position (x, y) data where the skill event information of one player who makes a pass and position (x, y) data where the skill event information of a player who receives the pass is generated into one waveform.

After the step S16, the information waveform providing server 300 generates a frequency waveform graph (S17).

To be more specific, the information waveform providing server 300 sets position information of the center of the stadium provided in step S14 as a center position for generating a waveform graph and sets a waveform graph parameter matching the real-time attack direction information, that is, a color and a graph type to generate a real-time waveform graph.

Further, In the meantime, when a player corresponding to one player's squad number, among real-time external data, makes a pass, among the skills, according to the real-time analysis in the step S14, and skill event information about a player, other than the player who uses the generated skill is not generated in step S14, or skill event information corresponding to an opponent player who is the player other than the player using the generated skill is generated, the information waveform providing server 300 generates the real-time waveform graph to recognize that the turn-over occurs by fixing a y-axis (longitude) like the section A of FIG. 8 and advancing a predetermined distance to an opponent side on the x-axis where skill event information is generated.

After the step S17, when the digital content server 500 completes the providing of the selected football broadcast content or there is a request for stopping the selected football broadcast content by the smart terminal 100, the information waveform providing server 300 determines whether the match is out (S18).

As a result of the determination of step S18, if the match is out, the information waveform providing server 300 returns to the step S11 to wait for a request of another football match broadcast from the smart terminal 100 or in contrast, if the match is not out, the information waveform providing server 300 ends the service after completing the broadcast for the football broadcast content.

The present disclosure may also be implemented as computer-readable codes written on a computer-readable recording medium. The computer-readable recording media includes all types of recording apparatuses in which data that can be read by a computer system is stored.

Examples of the computer readable recording medium are ROM, RAM, CD-ROM, a magnetic tape, a floppy disk, an optical data storing device and also implemented as a carrier wave (for example, transmission through the Internet).

Further, the computer readable recording medium is distributed in computer systems connected through a network and a computer readable code is stored therein and executed in a distributed manner. Further, a functional program, code, and code segment which may implement the present invention may be easily deducted by a programmer in the art.

In the meantime, exemplary embodiments of the present disclosure have been disclosed in the specification and the drawings and specific terms are used therein. However, this is used for a general meaning to easily explain the technical content of the present disclosure and help to understand the invention, but does not limit the scope of the present disclosure. It is obvious to those skilled in the art that modifications based on the technical spirit of the present disclosure, other than the disclosed exemplary embodiment are allowed.

What is claimed is:

1. A real-time information waveform converting system based on a real-time attack position and attack situation information of a match, comprising:
a real-time analysis server which analyzes one or more football players to generate football player information;
a plurality of digital content servers which provides football broadcast contents via on-line; and
an information waveform providing server which provides a football wave corresponding to a real-time waveform graph based on a real-time attack position and attack situation information of a football match for the football broadcast content to a smart terminal together with the football player information.

2. The real-time information waveform converting system according to claim 1, wherein the real-time analysis server automatically or manually analyzes real-time external data for at least one or more players of both teams in one football match in a football broadcast content provided by the digital content server and then provides the analyzed data to the information waveform providing server.

3. The real-time information waveform converting system according to claim 1, wherein the football wave which represents real-time information waveform based on a real-time attack position and attack situation information of a football match is a digital graphic which convert real-time collected data of football matches into a digital signal, that is, an information waveform (frequency), including the meaning of attack positions, attack build-up, attack strengths, etc., just as the intensity of voice or sound is converted into an information waveform (frequency) which is a digital signal.

4. The real-time information waveform converting system according to claim 1, wherein the information waveform providing server includes:
a transceiver which receives real-time external data and provides the real-time waveform graph to the smart terminal;
a controller which generates the real-time waveform graph; and
a database which stores a content data unit divided by a predetermined image frame section.

5. The real-time information waveform converting system according to claim 4, wherein the controller includes:
an information collection module which receives football broadcast information which is currently being provided from the plurality of digital content servers at a predetermined cycle or in real-time through a network;
a first analysis module which generates position (x, y) data for generating a graph with a frequency waveform curve by utilizing player passing points (X, Y) as vertexes, as real-time player skill point on a virtual area with the same frequency as a football field;
a second analysis module which analyzes player data by extracting desired data, among data about the player, by means of real-time external data analysis for a second object recognized by the first analysis module 3 to provide analysis information according to each data parameter in the real-time external data;
a waveform conversion module which receives data analyzed by the first analysis module and the second analysis module to convert position (x, y) where skill event information is generated into one waveform;
an information providing module which controls the transceiver to provide the real-time waveform graph generated in the waveform conversion module and real-time external data about a football player who generates skill event information related to the generation of the real-time waveform graph to the smart terminal through the network; and.
an additional information providing module which generates a data record obtained by converting an attack skill of one football player for a skill into a football big-data code.

6. The real-time information waveform converting system according to claim 5, wherein the information collection module performs:
a first information collecting process of repeatedly storing and deleting a content data unit divided by a predetermined image frame section on and from the database for analysis for the football broadcast content of the first analysis module and the second analysis module; and
a second information collecting process of receiving real-time external data in response to a real-time AI analysis request for the football broadcast content from the real-time analysis server and receiving the real-time external data matching a time order when each image frame which configures the content data unit is stored on the database.

7. The real-time information waveform converting system according to claim 5, wherein the first analysis module analyzes an attack direction of the second object along the length of the x-axis of the field and along the length of the y- and sets a center of the field in the analyzed attack direction as a center for the information waveform to provide real-time attack direction information and position information of the center of the field on the content data to the waveform conversion module.

8. The real-time information waveform converting system according to claim 5, wherein when a player corresponding to one player's squad number, among real-time external data, makes a pass, among the skills, according to the real-time analysis by the second analysis module and skill event information about a player other than the player who uses the occurred skill by the first analysis module is generated and transmitted again, the waveform conversion module converts position (x, y) data where the skill event information of one player who makes a pass, generated in the first analysis module is generated and position (x, y) data where the skill event information of a player who receives the pass is generated into one waveform and sets position information of a center of the field provided by the first analysis module as a center position for generating a waveform graph and sets a waveform graph parameter according to the real-time attack direction information to generate a real-time waveform graph.

9. The real-time information waveform converting system according to claim 8, wherein when a player corresponding to one player's squad number, among real-time external data, makes a pass, among the skills, according to the real-time analysis by the second analysis module and skill event information about a player, other than the player who uses the generated skill is not generated by the first analysis module or skill event information corresponding to an opponent player who is the player other than the player using the generated skill is generated, the waveform conversion module generates the real-time waveform graph to recognize that the turn-over occurs by fixing a y-axis (longitude) and advancing a predetermined distance to an opponent side on the x-axis where skill event information is generated.

10. A real-time information waveform converting method based on a real-time attack position and attack situation information of a match, comprising:
a first step of allowing a smart terminal to provide a request for a selected football broadcast to an information waveform providing server through a network; and
a second step of allowing the information waveform providing server to provide football broadcast contents provided from a plurality of digital content servers to the smart terminal together with football player information provided from a real-time analysis server based on a football wave corresponding to a real-time information waveform based on a real-time attack position and attack situation information of a football match.

11. The real-time information waveform converting method according to claim 10, wherein the real-time analysis server automatically or manually analyzes real-time external data for at least one or more players of both teams in one football match in a football broadcast content provided by the digital content server and then provides the analyzed data to the information waveform providing server.

12. The real-time information waveform converting method according to claim 10, wherein the football wave which represents real-time information waveform based on a real-time attack position and attack situation information of a football match is a digital graphic which convert real-time collected data of football matches into a digital signal, that is, an information waveform (frequency), including the meaning of attack positions, attack build-up, attack strengths, etc., just as the intensity of voice or sound is converted into an information waveform (frequency) which is a digital signal.

13. A computer readable recording medium in which a program which executes the real-time information waveform converting method according to claim 10 is stored.

14. A computer readable recording medium in which a program which executes the real-time information waveform converting method according to claim 11 is stored.

15. A computer readable recording medium in which a program which executes the real-time information waveform converting method according to claim 12 is stored.
